(19) United States
(12) Patent Application Publication
(10) Pub. No.: US 2024/0364209 A1
(43) Pub. Date: Oct. 31, 2024

(54) CURRENT DAMPING FOR DC-DC CONVERTER

(71) Applicant: Infineon Technologies AG, Neubiberg (DE)

(72) Inventors: Giovanni Bisson, Padova (IT); Stefano Zampieri, Padova (PD) (IT)

(21) Appl. No.: 18/308,180

(22) Filed: Apr. 27, 2023

(51) Int. Cl. H02M 1/15; H02M 1/08; H02M 3/158

(52) U.S. Cl. CPC H02M 1/15; H02M 1/08; H02M 3/158

(57) ABSTRACT

A device may drive, during a first portion of a switching period, a first switching element to electrically connect a switching node to a first node of a supply. The switching node is configured to couple to a first node of an inductive element. The device may drive, during a second portion of the switching period, a second switching element to electrically connect the switching node to a second node of the supply of the controller circuitry. The device may drive, during a third portion of the switching period, the first switching element to refrain from connecting the switching node to the first node of the supply of the controller circuitry, the second switching element to refrain from connecting the switching node to the second node of the supply, and a third switching element to electrically connect the switching node to a second node of the inductive element.

### TECHNICAL FIELD

This disclosure relates to circuits and techniques for direct current to direct current DC-DC converters.

### BACKGROUND

A driver circuit, or controller circuitry, may generate one or more switching signals to operate a DC-DC converter. The controller circuitry may control a voltage, current, and/or power output by the DC-DC converter using a duty cycle of the switching signal. For example, the driver circuit may generate the switching signal with a duty cycle to regulate a voltage output by a Buck converter.

### SUMMARY

In general, this disclosure is directed to techniques for damping oscillatory currents induced in a DC-DC converter during operation in discontinuous conduction mode (DCM). During DCM, controller circuitry may generate one or more switching signals to drive one or more switching elements. By driving the switching elements, the controller circuitry may convert a supply voltage or current into an output voltage or current. For instance, each switching signal may be a pulse-frequency modulated (PFM) signal having a switching period. During a first portion of the switching period of the PFM signal, the controller circuitry may cause, using the PFM signal, a first switching element to operate in a high side switching state. During a second portion of the switching period, a second switching element may operate in a low side switching state. During a third portion of the switching period, the first switching element and the second switching element may operate in an DCM state.

Switching between the portions of the switching period may induce undesirable oscillatory currents in the inductive element. For example, the oscillatory current or electrical ringing may be induced by electrical resonances formed between the inductive element and capacitive elements and/or parasitic capacitance. For instance, the oscillatory currents may include currents that occur when a charge on the capacitance of the DC-DC converter discharges into the inductive element. Charge flowing into the inductive element may be stored as magnetic fields around the inductive element before discharging back as current flowing into capacitive element. The oscillatory current from the capacitance to the inductive element and back to the capacitance may be repetitive and periodic.

Using one or more techniques described in this disclosure, controller circuitry may dampen or eliminate the oscillatory currents generated between the inductive element and the capacitive element. For example, when a switching element connected in parallel with the inductance of the resistor-inductor-capacitor series circuit of the DC-DC converter is closed, the inductance of the resistor-inductor-capacitor series circuit decreases. For example, the third switching element may electrically connect a first node of the inductive element to a second node of the inductive element during the third portion of the switching period. Using the third switching element in this way may cause the oscillatory currents to rapidly decay and/or settle closer to zero compared to systems that omit the third switching element. Damping the electrical oscillatory currents may help to improve the precision of a current and/or voltage output of the DC-DC converter, which may help to improve the functionality of a load.

In one example, controller circuitry includes a switching controller configured to determine a switching period. The controller circuitry may include logic circuitry electrically coupled with the switching controller and configured to drive, during a first portion of a switching period, a first switching element to electrically connect a switching node to a first node of a supply. During the first portion of the switching period, the switching node may be configured to couple to a first node of an inductive element. The controller circuitry is further configured to drive, during a second portion of the switching period, a second switching element to electrically connect the switching node to a second node of the supply. The controller circuitry may be further configured to drive, during a third portion of the switching period, the first switching element to refrain from connecting the switching node to the first node of the supply. The second switching element of the controller circuitry, further configured to refrain from connecting the switching node to the second node of the supply. A third switching element of the controller circuitry, configured to electrically connect the switching node to a second node of the inductive element.

In another example, the disclosure describes a method including driving, during a first portion of a switching period, a first switching element to electrically connect a switching node to a first node of a supply. The switching node configured to couple to a first node of an inductive element. The method also including driving, during a second portion of the switching period, a second switching element to electrically connect the switching node to a second node of the supply of the controller circuitry. Including in the technique, driving, during a third portion of the switching period, the first switching element to refrain from connecting the switching node to the first node of the supply of the controller circuitry, the second switching element to refrain from connecting the switching node to the second node of the supply, and a third switching element to electrically connect the switching node to a second node of the inductive element.

In one example, this disclosure describes a system including a first switching element, a second switching element, a third switching element, and a controller circuitry. The controller circuitry may include a switching controller configured to determine a switching period. The controller circuitry may include logic circuitry electrically coupled with the switching controller and configured to drive, during a first portion of the switching period, the first switching element to electrically connect a switching node to a first node of the supply. The controller circuitry may be further configured to drive, during a third portion of the switching period, the first switching element to refrain from connecting the switching node to the first node of the supply. The logic circuitry may be configured to drive, during a third portion of the switching period, the first switching element to refrain from connecting the switching node to the first node of the supply, the second switching element to refrain from connecting the switching node to the second node of the supply, and the third switching element to electrically connect the switching node to a second node of the inductive element.

Details of these and other examples are set forth in the accompanying drawings and the description below. Other features, objects, and advantages will be apparent from the description and drawings, and from the claims.

### BRIEF DESCRIPTION OF DRAWINGS

FIG. 1 is a conceptual block diagram illustrating an example system for driving (e.g., using, controlling, operating, directing a signal to, or switching) switching elements to dampen oscillatory currents in a DC-DC converter, in accordance with one or more techniques of this disclosure.

FIG. 2 is a circuit diagram illustrating example system for implementing a NPN BJT as a switching element in a DC-DC converter, in accordance with one or more techniques of this disclosure

FIG. 3 is a circuit diagram illustrating example system for implementing two NPN BJTs in a Darlington configuration as a switching element in a DC-DC converter, in accordance with one or more techniques of this disclosure.

FIG. 4 is a conceptual block diagram illustrating an example system for dampen oscillatory currents in a DC-DC converter having parasitic impedances, in accordance with one or more techniques of this disclosure.

FIG. 5A is a graph illustrating an example of an electrical current signal having an undamped portion when operating DC-DC converter in DCM, in accordance with one or more techniques of this disclosure.

FIG. 5B is a graph illustrating an example of an electrical current signal having a damped portion when operating DC-DC converter in DCM, in accordance with one or more techniques of this disclosure.

FIG. 6 is a flow diagram consistent with techniques that may be performed by the example system of FIG. 1, in accordance with this disclosure.

### DETAILED DESCRIPTION

This disclosure is directed to circuitry, systems, and techniques for damping currents induced at the output of a DC-DC converter during operation of the DC-DC converter. A DC-DC converter may convert a voltage of a supply to a lower or higher output voltage. One type of DC-DC converter, for example, is a switched mode DC-DC converter, such as, for example, a Buck converter. A DC-DC converter may operate in a discontinuous conduction mode (DCM) or in a continuous conduction mode (CCM). While operating in DCM, CCM, or other converter modes, the DC-DC converter may induce undesired oscillatory currents. For example, DC-DC converters operating in DCM may induce oscillatory currents when switching to an DCM state. In some examples, DC-DC converters operating in CCM may induce oscillatory currents during a deadtime. The following describes techniques for damping oscillatory currents induced by DC-DC converters.

DC-DC converters may include controller circuitry configured to switch the DC-DC converter between a variety of switching states. For example, the controller circuitry may be configured to generate switching signals to drive switching elements to regulate a voltage or current output by the DC-DC converter. The switching signals may have a common switching period. For example, each of the switching signals may have a switching period with the same duration of time and initiated at a common time. In some examples, driving the switching elements may include configuring the controller circuitry to operate in a three-state mode (e.g., operating the switching elements as a tri-state buffer). For example, controller circuitry operating in the three-state mode, may drive switching elements to switching between a high side switching state, a low side switching state, and an DCM state.

During the three-state mode, a switching node of the DC-DC converter may be electrically switched into three different electrical configurations using the switching elements. Controller circuitry may drive the switching elements to switch between each electrical configuration. Each electrical configured may correspond with a switching state. For example, during the high side switching state, the controller circuitry may drive switching elements to electrically connect the switching node to a supply voltage. During the low side switching state, the controller circuitry may drive switching elements to electrically connect the switching node to a supply ground (e.g., a reference node, an earth ground, or another voltage). During the DCM state, also referred to herein as a DCM period, the controller circuitry may cause the switching elements to electrically disconnect the switching node from both the supply voltage and the supply ground.

Undesirable oscillatory currents may be induced in the DC-DC converter when the control circuitry drives switching elements to transition from a low side switching state to an DCM state. Currents induced by reactive components of the DC-DC converter may become oscillatory in the presence of an abrupt change to a supplied current and/or voltage (e.g., transitioning states with switching elements). An abrupt change in current and/or voltage may include charging and discharging of electrical energy in the reactive elements inducing oscillatory currents. For example, energy may be stored in magnetic fields as current flows through an inductive element during a low side switching state. Upon disconnecting a node of the inductive element (e.g., the switching node) from the second potential of the supply, the stored magnetic energy may induce current to flow from the inductive element to a capacitive element. The capacitive element may store the current it receives as an electrical charge. Once charged, the capacitive element may discharge the stored electrical charge as a current flow, flowing into the inductive element. Upon switching from a low side switching state to an DCM state, electrical resonances created by the electrical interactions between inductive elements and capacitive elements, may induce oscillatory currents in the DC-DC converter.

Techniques described herein may use switching elements to dissipate stored energy in reactive elements (e.g., one or more inductive elements and/or one or more capacitive elements), which may dampen undesired oscillatory currents. For example, dissipating energy stored in the reactive elements may dampen an amplitude of oscillatory currents induced in the DC-DC converter, by introducing parasitic losses (e.g., a resistance of the switching element).

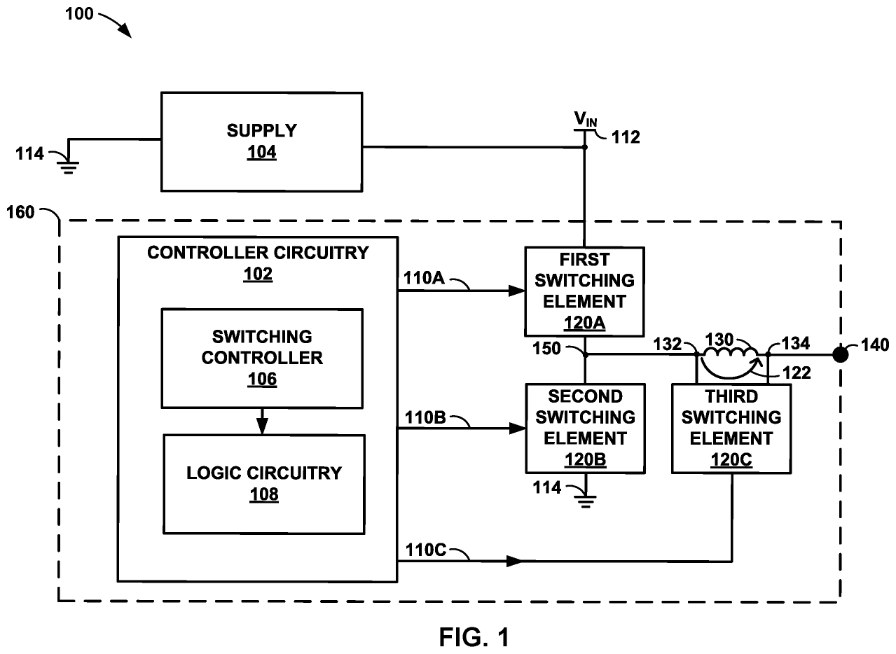

FIG. 1 is a conceptual block diagram illustrating an example system 100 for driving (e.g., using, controlling, operating, directing a signal to, or switching) switching elements to dampen oscillatory currents in a DC-DC converter, in accordance with one or more techniques of this disclosure. As illustrated in the example of FIG. 1, system 100 may include a supply 104, a first switching element 120A, a second switching element 120B, a third switching element 120C (collectively, “switching elements 120”), controller circuitry 102, and an inductive element 130. Inductive element 130 may be formed using one or more inductive elements connected in series or parallel. For example, inductive element 130 may include one or more discrete inductive elements and/or one or more distributed inductive elements formed as metallization layers on an integrated circuit (IC).

Controller circuitry 102 may include switching controller 106 and logic circuitry 108. Switching controller 106 and/or logic circuitry 108 may be implemented in hardware, firmware, or a combination of hardware and firmware. For example, controller circuitry 102 may include one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing switching circuitry and/or logic circuitry, alone or in combination with other logic circuitry, or any other equivalent circuitry. In some examples, logic circuitry 108 and/or switching controller 106 may be a combination of one or more analog components and one or more digital components.

Controller circuitry 102 may be configured to drive first switching element 120A with first switching signal 110A, second switching element 120B with second switching signal 110B, and third switching element 120C with third switching signal 110C. To drive switching elements 120, switching controller 106 of controller circuitry 102 may be configured to determine a switching period of switching signals 110 for operating DC-DC converter 160 in DCM. For example, switching controller 106 may determine the switching period to include a first portion, a second portion, a third portion, and a fourth portion. Switching controller 106 may output the switching period to logic circuitry 108.

Logic circuitry 108 may be coupled to switching controller 106 and may be configured use the determined switching period output by switching controller 106 to generate a first switching signal 110A, a second switching signal 110B, and a third switching signal 110C (collectively “switching signals 110”). For example, logic circuitry 108 may generate, based on the switching period output by switching controller 106, switching signals 110 (e.g., PFM or pulse-width modulated (PWM) signals). In some examples, switching signals 110 may have a common switching period. For example, first switching signal 110A, second switching signal 110B, and third switching signal 110C may have synchronized switching periods with the same time duration.

Switching elements 120 may include, but are not limited to, for example, a silicon-controlled rectifier (SCR), a Field Effect Transistor (FET), and a bipolar junction transistor (BJT). Examples of FETs may include, but are not limited to, a junction field-effect transistor (JFET), a metal-oxide-semiconductor FET (MOSFET), a dual-gate MOSFET, an insulated-gate bipolar transistor (IGBT), any other type of FET, or any combination of the same. Examples of MOSFETS may include, but are not limited to, a depletion mode p-channel MOSFET (PMOS), an enhancement mode PMOS, depletion mode n-channel MOSFET (NMOS), an enhancement mode NMOS, a double-diffused MOSFET (DMOS), any other type of MOSFET, or any combination of the same. Examples of BJTs may include, but are not limited to, PNP, NPN, heterojunction, or any other type of BJT, or any combination of the same. In some examples, two or more of an SCR, a FET, or a BJT may be interconnected to form one or more of switching elements 120. Switching elements 120 may be configured to high-side or low-side switching elements. Additionally, switching elements 120 may be voltage-controlled and/or current-controlled. Examples of current-controlled switching elements may include, but are not limited to, gallium nitride (GaN) MOSFETs, BJTs, or other current-controlled elements.

When driven to a closed state by first switching signal 110A, first switching element 120A may be configured to electrically connect a first node 112 (e.g., an input voltage) of supply 104 to a switching node 150. When driven to a closed state by second switching signal 110B, second switching element 120B may be configured to electrically connect a second node 114 of supply 104 (e.g., a reference voltage) to switching node 150. When driven to a closed state by third switching signal 110C, third switching element 120C may be configured to electrically connect a first node 132 of an inductive element 130 to a second node 134 of inductive element 130.

Supply 104 may be configured to provide electrical power to one or more components of system 100. For example, a first node 112 of supply 104 may be electrically connected to first switching element 120A. Supply 104 may be configured to supply power to a load connected to output node 140 via DC-DC converter 160.

When connecting first node 132 to second node 134, third switching element 120C may electrically connect switching node 150 to an output node 140 of DC-DC converter 160. As shown, a first node 132 of inductive element 130 may be electrically connected to switching node 150 and a second node 134 of inductive element 130 may be electrically connected to output node 140.

DC-DC converter 160 may be configured to operate in the three-state mode having a low side switching state, a high side switching state, and a DCM state. In some examples, first switching element 120A may function as a high side switch, second switching element 120B may function as a low side switch, and third switching element 120C may function as an oscillatory current damper.

In some examples, during the first portion of the switching period, logic circuitry 108 of controller circuitry 102 may operate in the high side switching state. In the high side switching state, logic circuitry 108 may drive first switching element 120A with first switching signal 110A to a closed state, electrically connecting first node 112 of supply 104 to switching node 150. During the first portion of the switching period (e.g, high side switching state), logic circuitry 108 may refrain from electrically connecting switching node 150 to second node 114 of supply 104. For example, to refrain from connecting switching node 150 to second node 114 of supply 104, logic circuitry 108 may drive second switching element 120B with second switching signal 110B in an open state.

Logic circuitry 108 may operate switching elements 120 in the low side switching state during the second portion of the switching period. In the low side switching state, logic circuitry 108 may drive second switching element 120B with first switching signal 110B to a closed state, electrically connecting switching node 150 to second node 114 of supply 104. During the second portion of the switching period (e.g., low side switching state), logic circuitry 108 may refrain from electrically connecting switching node 150 to first node 112 of supply 104. For example, to refrain from connecting switching node 150 to first node 112 of supply 104, logic circuitry 108 may drive first switching element 120A with first switching signal 110A in an open state.

During the third portion of the switching period, logic circuitry 108 may operate switching elements 120 in the DCM state. During the DCM state, logic circuitry 108 may drive second switching element 120B with second switching signal 110B to an open state and refrain from electrically connecting switching node 150 to first node 112 of supply 104 via first switching element 120A. During the second portion of the switching period, logic circuitry 108 may drive second switching element 120B with second switching signal 110B, in an open state, refraining from electrically connecting switching node 150 to second node 114 of supply 104.

The transitioning of switching elements 120, from the low side switching state to the DCM state, may induce oscillatory currents in inductive element 130. For example, current flowing through inductive element 130 during the low side switching state may be interrupted when logic circuitry 108 electrically disconnects the first node 112 and second node 114 of supply 104 from switching node 150. Electrically disconnecting supply 104 from switching node 150 may interrupt the current flow through inductive element 130. The interruption of the current flow through inductive element 130 may cause undesired oscillatory currents in DC-DC converter 160.

The oscillatory currents may induce noise on a current signal flowing through inductive element 130. In some examples, system 100 may set modulation parameters of PFM signals based on measuring or sensing of the current signal flowing through inductive element 130. Damping the amplitude of oscillations in the current signal flowing through inductive element 130 may reduce an error in current measurement or current sensing used to determine one or more modulation parameters. For example, logic circuitry 108 may drive switching element 120C to form a low resistance path 122 for current to flow from node 132 and node 134. In this way, switching element 120C may dissipate energy stored by inductive element 130. For example, low resistance path 122 could include the intrinsic impedance path through third switching element 120C.

In accordance with the techniques of the disclosure, logic circuitry 108 may drive third switching element 120C to a closed state when operating in the DCM. In some examples, third switching element 120C may be implemented on an integrated chip (IC) that includes logic circuitry 108. Third switching element 120C may be implemented as a separate switching element external to the IC that includes logic circuitry 108.

In the closed state, third switching element 120C may lower the inductance between switching node 150 and output node 140. For example, third switching element 120C may electrically connect an intrinsic inductance of switching element 120C in parallel with inductive element 130, lowering the parallel combined inductance. Third switching element 120C may be isolated from the rest of the logic circuitry 108, which may reduce an impact of a parasitic diode effects.

Third switching element 120C may include one or more transistors. In some examples, third switching element 120C may include one or more of a NPN and/or a PNP transistor. In some examples, third switching element 120C may include two or more NPN transistors connected in series or parallel. Third switching element 120C may include, for example, two or more PNP transistors connected in series or parallel. Additional examples, include third switching element 120C connected in a Darlington configuration. Third switching element 120C may be implemented on n-type or p-type MOSFETs with programmable bulk configured to avoid back side diode conduction. In various examples, third switching element 120C may be arranged in an anti-serial MOSFET configuration. For example, in some MOSFETS having a source to body diode connection and a body to drain diode connection a parasitic diode effect may present. Implementing and n-type or p-type MOSFET with programmable bulk (e.g., avoiding back side diode conduction), an anti-serial MOSFET configuration, an NPN, a PNP, or a Darlington configuration may reduce the impact of a parasitic diode effect.

Low resistance path 122 formed by third switching element 120C in a closed state may convert electrical energy to heat. For instance, current flowing through low resistance path 122 may be converted to heat by the intrinsic resistance of third switching element 120C. Third switching element 120C may be configured to electrically connect first node 132 of inductive element 130 to second node 134 of third switching element, providing low resistance path 122 between switching node 150 and output node 140. During DCM, magnetically stored energy in inductive element 130 may dissipate as current when logic circuitry 108 drives third switching element 120 into a closed state. Current induced in inductive element 130 by the stored magnetic energy may be converted, for example, to heat by the impedance of third switching element 120 and inductive element 130.

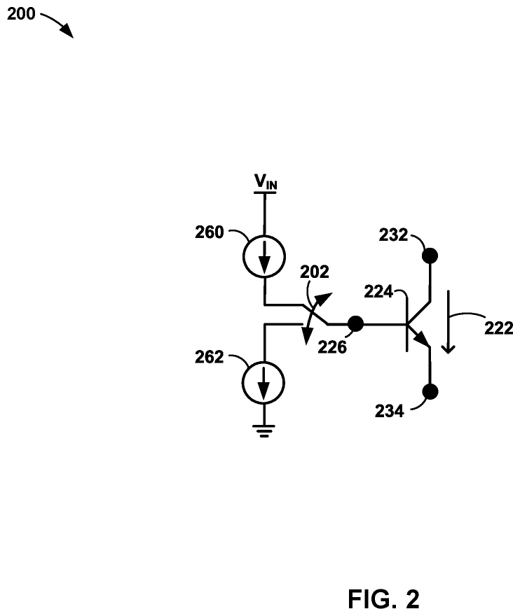

FIG. 2 is a circuit diagram illustrating example system 200 for implementing a NPN BJT 224 as a switching element in a DC-DC converter, in accordance with one or more techniques of this disclosure. FIG. 2 is discussed with reference to FIG. 1 for example purposes only. As illustrated in the example of FIG. 2, system 200 may include a first current source 260, a second current source 262, a switching element 202 and NPN BJT 224. NPN BJT 224 may be a switching element, for example third switching element 120C of FIG. 1. NPN BJT 224 includes a base 226, a collector 232, and an emitter 234.

Switching element 202 may connect base 226 to one of first current source 260 or second current source 262. For example, when switching element 202 connects first current source 260 to base 226, current from first current source 260 may drive NPN BJT 224 to a closed state. In this example, when switching element 202 connects second current source 262 to base 226, current from second current source 262 may drive NPN BJT 224 to an open state.

In some examples, switching element 202 may be omitted and the switching function of switching element 202 may be instead implemented by controlling an operation of first current source 260 and second current source 262. For example, to drive NPN BJT 224 to a closed state, first current source 260 may generate a current and second current source 262 may be set to a non-generating mode. To drive NPN BJT 224 to an open state, second current source 262 may generate a current and first current source 260 may be set to a non-generating mode.

During the closed state NPN BJT 224 may generate a conductive path 222, allowing current to flow from collector 232 to emitter 234. In some examples, the current flowing through conductive path 222 may be current induced, for example by inductive element 130 of FIG. 1. When switching element 202 connects second current source 262 to base 226 current from second current source 262 may drive NPN BJT 224 to an open state. During the open state NPN BJT 224 may generate an insulative path, preventing current from flowing between collector 232 and emitter 234

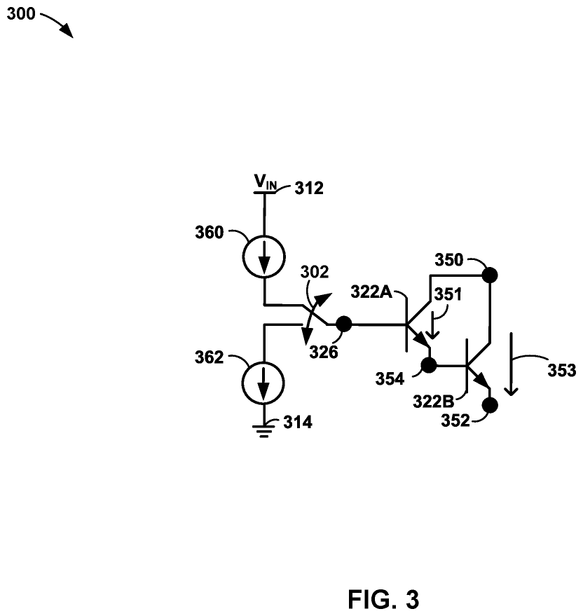

FIG. 3 is a circuit diagram illustrating example system 300 for implementing two NPN BJTs in a Darlington configuration as a switching element in a DC-DC converter, in accordance with one or more techniques of this disclosure. FIG. 3 is discussed with reference to FIGS. 1-2 for example purposes only. As illustrated in the example of FIG. 3, system 300 may include a first current source 360, a second current source 362, a switching element 302, first NPN BJT 322A, and second NPN BJT 322B. NPN BJT 322A and second NPN BJT 322B may have various nodes including a base, a collector, and an emitter. In the Darlington configuration as shown, a collector of first NPN BJT 322A may be electrically connected to a collector of second NPN BJT 322B at a first node 350. An emitter of first NPN BJT may be electrically connected to a base of second NPN BJT 322B at a second node 354. A base 326 of first NPN BJT 322A electrically connected to switching element 302.

First NPN BJT 322A and second NPN BJT 322B, when connected in a Darlington configuration, may operate together as a switching element, for example third switching element 120C of FIG. 1. When switching element 302 connects first current source 360 to base 326, for example, current from first current source 360 may drive first NPN BJT 322A to a closed state. In this example, when switching element 302 connects second current source 362 to base 326, current from second current source 362 may drive first NPN BJT 322A to an open state.

In some examples, switching element 302 may be omitted and the switching function of switching element 302 may be instead implemented by controlling an operation of first current source 360 and second current source 362. For example, to drive first NPN BJT 322A to a closed state, first current source 360 may generate a current and second current source 362 may be set to a non-generating mode. To drive first NPN BJT 322A to an open state, second current source 362 may generate a current and first current source 360 may be set to a non-generating mode.

When first NPN BJT 322A is in the closed state, current may flow from first node 350 to second node 354. Current flowing out of the emitter of first NPN BJT 322A may flow into the base of second BJT 322B, driving second BJT 322B to a closed state. In the closed state second BJT 322B may allow current to flow from first node 350 to emitter 352.

During a closed state first NPN BJT 322A may generate a conductive path 351 causing second NPN BJT 322B to generate a second conductive path 353. In some examples, second conductive path 353 may allow current from an inductive element, for example inductive element 130 of FIG. 1, to flow between first node 350 and emitter 352. In various examples, using NPN BJTs or other switching elements in a DC-DC converter, may introduce parasitic impedances into the DC-DC converter.

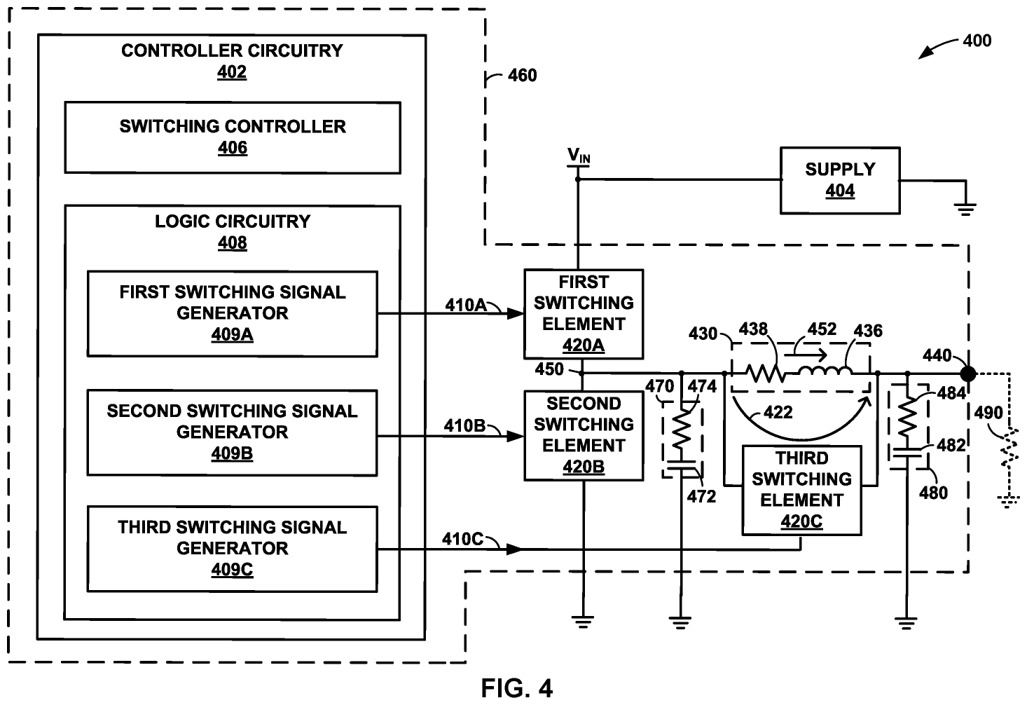

FIG. 4 is a conceptual block diagram illustrating an example system 400 for dampen oscillatory currents in a DC-DC converter 460 having parasitic impedances, in accordance with one or more techniques of this disclosure. System 400 may include DC-DC converter 460, supply 404, and electrical load 490. DC-DC converter 460 may include controller circuitry 402, a first switching element 420A, a second switching element 420B, a third switching element 420C, an inductive element 430, a capacitive element 480, and a parasitic impedance 470. First switching element 420A and second switching element 420B may be configured to alternately connect a switching node 450 to a first node (e.g., a supply voltage) or second node (e.g., a supply reference voltage) of supply 404. Inductive element 430, in parallel with third switching element 420C, may electrically connect switching node 450 to an output node 440. Capacitive element 480 may electrically connect output node 440 to second node (e.g., a reference node) of supply 404. Parasitic impedance 470 may include parasitic impedances, from, for example, switching element 420A and switching element 420B. For example, a parasitic capacitance 472 may include a parasitic capacitance from first switching element 420A and second switching element 420B. In some examples, the parasitic capacitance from first switching element 420A and second switching element 420B may result from packaging, routing, transistor capacitances, or other parasitic capacitances introduced when implementing first switching element 420A and second switching element 420B into DC-DC converter 460.

Controller circuitry 402 may include switching controller 406 and logic circuitry 408. Logic circuitry 408 may include a first switching signal generator 409A, a second switching signal generator 409B, and a third switching signal generator 409C (collectively “switching signal generators 409”). Logic circuitry 408 may be configured to drive first switching element 420A, second switching element 420B, and third switching element 420C (collectively “switching elements 420”) based on a three-state mode. Switching controller 406 of controller circuitry 402 may be configured to determine a switching period. Based on the determined switching period, logic circuitry 408 of controller circuitry 402 may control first switching signal generator 409A to generate first switching signal 410A, control second switching signal generator 409B to generate second switching signal 410B, and control third switching signal generator 409C to generate third switching signal 410C.

DC-DC converter 460 may drive first switching element 420A, second switching element 420B, and third switching element 420C (collectively “switching elements 420”) with first switching signal 410A, second switching signal 410B, and third switching signal 410C (collectively “switching signals 410”).

During a high side switching state of the three-state mode, first switching signal generator 409A may drive first switching element 420A to connect first node (e.g., a supply node (V_{IN})) of supply 404 to a switching node 450. During the high side switching state, current may flow from second node of supply 404 through first switching element 420A, through inductive element 430, and into electrical load 490 connected to output node 440.

An output node 440 may include a pin extending from an IC package or it may include an internal node within the IC. Electrical load 490 may include electrical circuitry having a resistance value. In some examples, electrical load 490 may include a resistance and zero or more of a capacitance or a inductance which produces a DC load. Electrical current passing through inductive element 430 may induce magnetic fields within inductive element 430. The magnetic fields may impact current flow through inductive element 430 as controller circuitry 402 switches to a low side switching state.

During a low side switching state of the three-state mode, second switching signal generator 409B may drive second switching element 420B to connect second node (e.g., a reference node) of supply 404 to a switching node 450. During the low side switching state, current through inductive element 430 may decrease as first switching element 420A disconnects first terminal of supply 404 from switching node 450.

During the DCM state, controller circuitry 402 may electrically disconnect switching node 450 from both first node and second node of supply 404. A portion of current flowing through inductive element 430 during the DCM state may flow into capacitive element 480 and parasitic capacitance 472. In some examples, an electromagnetic interaction between inductance 436 of inductive element 430 and a parasitic capacitance 472 may cause oscillatory currents in inductive element 430. Oscillatory currents may be generated as a charge stored in parasitic capacitance 472 is discharged as a current through inductive element 430. Inductive element 430 may temporarily store energy from the current in magnetic fields before discharging the stored energy as current flowing into parasitic capacitance 472.

Inductive element 430 may be an example of inductive element 130 of FIG. 1. Inductive element 436 may represent an ideal lossless inductive element 430 and equivalent series resistance (ESR) 438 that represents the inherent resistance within inductive element 430. Inductive element 430 may include an air core inductor, laminated inductor, iron-core inductor, toroidal inductor, ceramic chip inductor, integrated spiral inductor, or other element with an inductive reactance.

DC-DC converter 460 may include capacitive element 480 of DC-DC converter 460 configured to filter an output voltage potential on output node 440. Capacitive element 480 along with inductive elements 430 and output load 490 may form a resistive inductive capacitive (RLC) resonant circuit that impacts the current and the voltages across the passive elements (e.g., capacitive element 480, inductive element 430, and load 490). In some examples, an ESR 474, an inductive element ESR 438, and a capacitive element ESR 484 may contribute to a total parasitic resistance of DC-DC converter 460. In some examples, parasitic capacitance 472 of parasitic impedance 470 may contribute to the total capacitance measured between switching node 450 and second node of supply 404. Based on electromagnetic interaction between capacitance 482, inductance 436, and parasitic capacitance 472, oscillatory currents may be exacerbated during the DCM state.

Oscillating currents induced from the electromagnetic interactions may partially decay from ESR 484 and ESR 474. During the DCM state, third switching signal generator 409C may drive third switching element 420C to a closed state, electrically connecting a first node of inductive element 430 to a second node of inductive element 430. Electrically connecting the first node to the second node of inductive element 430 may cause current to flow through ESR 438, which may dissipate energy and/or reduce oscillatory currents. Switching signals 410 may incorporate a dead time to avoid cross conduction between first switching element 420A and third switching element. For example, switching signals 410 may incorporate a dead time at the end of the third portion of the switching period before driving first switching element 420A to a closed state at the beginning of the following switching period.

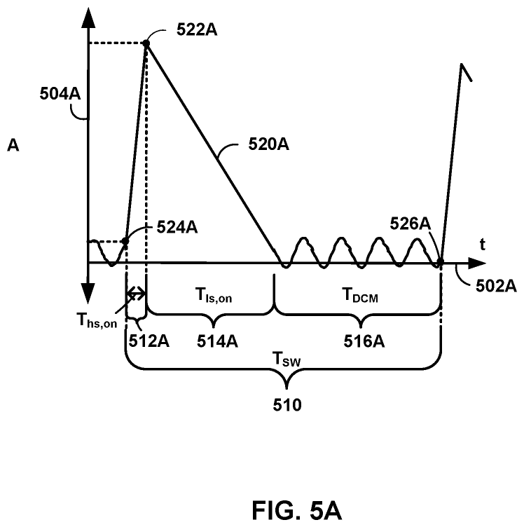

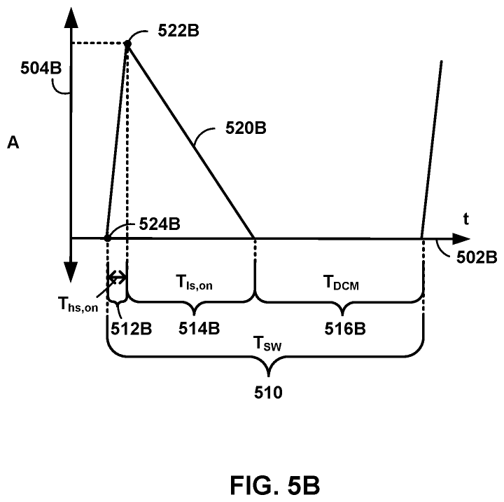

FIG. 5A is a graph illustrating an example of an electrical current signal 520A having an undamped portion when operating DC-DC converter 160 in DCM, in accordance with one or more techniques of this disclosure. A horizontal axis 502A represents time (t) over a duration of a switching period (T_{SW}) 510, and a vertical axis 504A represents electrical current signal 520A through inductive element 130 of FIG. 1 in amps (A). Electrical current amplitudes above horizontal axis 502A are positive, representing current flowing from inductive element 130 toward an output node 140. Electrical current amplitudes below horizontal axis 502A are negative, representing current flowing from the inductive element 130 toward a switching node 150. FIG. 5B is discussed with reference to FIGS. 1-4 for example purposes only.

During first portion 512A (T_{hs_on}) of switching period 510, current flows through inductive element 130 when DC-DC converter 160 is configured in a high side switching state (T_{hs,on}). In the example of FIG. 5A, electrical current signal 520A has an initial current value I₁(0) 524A above zero. Electrical current signal 520A may increase linearly from initial current value I₁(0) 524A to a peak current value 522A.

In some examples, system 100 may use initial current value 524A set to zero to estimate peak current value 522A, which may introduce error in the estimation of the peak current. For example, system 100 may estimate peak current value (i_{L,peak}) using EQUATION 1.

$${i}_{L , peak} = \frac{( {V}_{in} - {V}_{out} ) \cdot {t}_{hs , on}}{L} + {i}_{L} ( 0 ) \qquad EQUATION 1$$

where i_{L,peak} is a peak current value 522A. Vᵢₙ is a supply voltage, Vₒᵤₜ is an output voltage, t_{hs,on} is time duration, and L is an inductance, and i_{L}(0) is an initial current value.

During second portion 514A (T_{ls,on})) of switching period 510, current flows through inductive element 130 when DC-DC converter 160 is configured in a low side switching state. During the low side switching state, current flowing through inductive element 130 may decrease. In the example of FIG. 5A, current signal 520A may decrease from peak current value 522A to zero.

During third portion 516A of switching period 510, current flows through inductive element 130 when DC-DC converter 160 is configured in a DCM state (T_{DCM}). In some examples, the current flowing through inductive element 130 during the DCM state (T_{DCM}) may be undamped. During DCM state, undamped current flowing through inductive element 130 may be an oscillatory current. Controller circuitry 102 may drive third switching element 120C to dampen the oscillatory currents flowing through inductive element 130, as illustrated in FIG. 5B.

In some examples, a duration of the switching period T_{sw} may influence the duration of DCM state (T_{DCM}). The switching period T_{sw} may be fixed by design when implementing pulse frequency modulation (PFM) techniques on the switching signals. T_{sw} may depend on the values of Vᵢₙ, Vₒᵤₜ, I_{L,avg}, L and t_{hs,on} when implementing PFM. In various examples, an initial current level i_{L}(0) flowing through inductive element 130 at the start of a new switching period T_{sw} may be above or below zero due to the undamped portion of electrical current signal 520.

FIG. 5B is a graph illustrating an example of an electrical current signal 520B having a damped portion when operating DC-DC converter 160 in DCM, in accordance with one or more techniques of this disclosure. A horizontal axis 502B represents time (t) over a duration of a switching period (T_{SW}) 510, and an vertical axis 504B represents damped electrical current signal 520B through inductive element 130 of FIG. 1 in amps (A). Electrical current amplitudes above horizontal axis 502B are positive, representing current flowing from inductive element 130 toward an output node 140. Electrical current amplitudes below horizontal axis 502B are negative, representing current flowing from the inductive element 130 toward a switching node 150. FIG. 5B is discussed with reference to FIGS. 1-4 and 5A for example purposes only.

During first portion 512A of switching period 510, current flows through inductive element 130 when DC-DC converter 160 is configured in a high side switching state (T_{hs,on}). In the example of FIG. 5B, damped electrical current signal 520B has an initial current value I₁(0) 524B of zero. Current signal 520B may increase linearly from zero to a peak current value 522B.

During second portion 514B of switching period 510, current flows through inductive element 130 when DC-DC converter 160 is configured in a low side switching state (T_{ls,on}). During the low side switching state (T_{ls,on}), current flowing through inductive element 130 may decrease. In the example of FIG. 5B, damped electrical current signal 520B may decrease from peak current value 522B to zero.

During third portion 516A of switching period 510, current flowing through inductive element 130 may be zero in a DCM state (T_{DCM}), when the oscillatory currents are damped. For example, when third switching element 120C connects both terminals of inductive element 130 together, current flow may be zero.

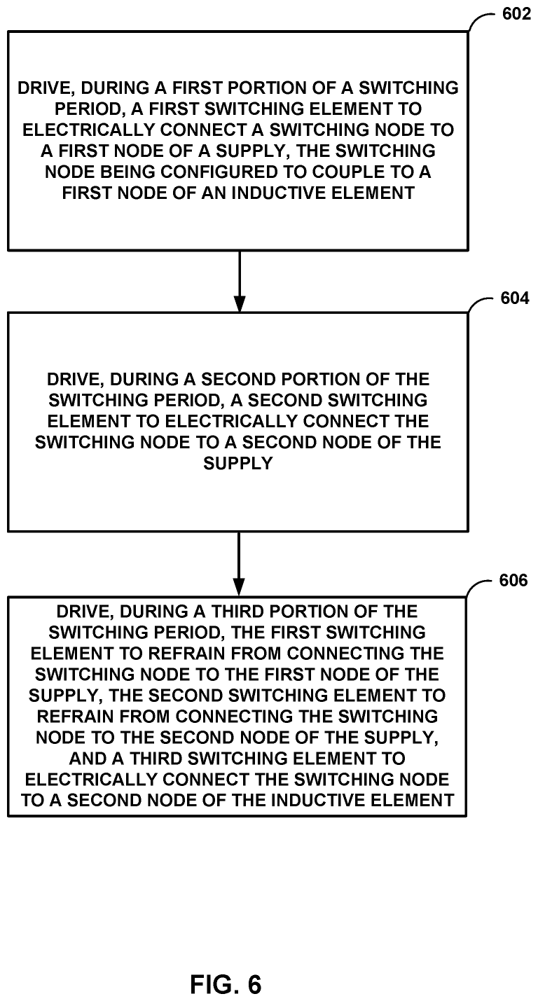

FIG. 6 is a flow diagram consistent with techniques that may be performed by the example system of FIG. 1, in accordance with this disclosure. FIG. 6 is discussed with reference to FIGS. 1-4 and 5A-5B for example purposes only.

Controller circuitry 102, or more specifically, for example, logic circuitry 108 or first switching signal generator 409A, may drive, during a first portion of a switching period, a first switching element 120A to electrically connect a switching node 150 to a first node 112 of a supply 104, the switching node 150 being coupled to a first node 132 of inductive element 130 (602). For example, controller circuitry 102 may drive first switching element 120A to electrically connect supply 104 to switching node 150. The first switching element may include first switching element 120A of FIG. 1. During the first portion of time, after the first switching element electrically connects the switching node to the first node of the supply, a current through the inductive element may be represented by first portion 512B of FIG. 5B. For instance, first switching signal generator 409A may generate a first PFM switching signal to cause first switching element 420A to operate in a closed state.

In some examples, the DC-DC converter may include a capacitive element electrically connected to the second node of the inductive element. For example, capacitive element may include capacitive element 480 of FIG. 4. In some examples, the inductive element of the controller circuitry may be configured to form a Buck converter.

Controller circuitry 102, or more specifically, for example, logic circuitry 108 or second switching signal generator 409B may be configured to drive, during a second portion of the switching period, second switching element 120B to electrically connect switching node 150 to second node 114 of supply 104 (604). For example, controller circuitry 102 may operate switching elements 120 in a low side switching state connecting switching node 150 to a reference voltage (e.g., second node 114 of supply 104). During the second portion of time, after the second switching element electrically connects the switching node to the second node of the supply, a current through the inductive element may be represented by second portion 514B of FIG. 5B. For instance, second switching signal generator 409B may generate a second PFM switching signal to cause second switching element 420B to operate in a closed state.

Controller circuitry 102 may be configured to drive, during a third portion of the switching period, first switching element 120A to refrain from connecting switching node 150 to first node 112 of supply 104, second switching element 120B to refrain from connecting switching node 150 to second node 114 of supply 104, and third switching element 120C to electrically connect switching node 150 to a second node 134 of inductive element 130 (606). During the third portion of time, after first switching element 120A electrically disconnects switching node 150 from first node 112 and second node 114 of supply 104, a current through inductive element 130 may be represented by third portion 516B of FIG. 5B. For instance, third switching signal generator 409C may generate a third PFM switching signal to cause third switching element 420C to operate in a closed state.

In some examples, controller circuitry 102 may be further configured to drive, during a fourth portion of the switching period, first switching element 120A to refrain from connecting switching node 150 to first node 112 of supply 104. During the fourth portion, controller 102 may control second switching element 120B to refrain from connecting switching node 150 to second node 114 of supply 104. Controller circuitry 102, during the fourth portion, may configure third switching element 120C to refrain from electrically connecting switching node 150 to second node 134 of inductive element 130.

In some examples, a first node of third switching element 120A is electrically connected to switching node 150. In this example, a second node of third switching element 120C is electrically connected to output node 140. First node 132 of inductive element 130 may be electrically connected to switching node 150 and second node 134 of inductive element 130 may be electrically connected to output node 140.

In some examples, third switching element 120C may include one or more transistors integrated in the controller circuitry on a common integrated circuit (IC). In some examples, third switching element 120C includes one or more NPN transistors. For example, third switching element 120C may include a field effect transistor (FET), an example of an NPN BJT. Third switching element 120C may include one or more PNP transistors. In some examples, third switching element 120C may include two transistors configured in a Darlington configuration.

The following clauses may illustrate one or more aspects of the disclosure.

Clause 1: Controller circuitry comprising: a switching controller configured to determine a switching period; and logic circuitry electrically coupled with the switching controller and configured to: drive, during a first portion of the switching period, a first switching element to electrically connect a switching node to a first node of a supply, the switching node being configured to couple to a first node of an inductive element; drive, during a second portion of the switching period, a second switching element to electrically connect the switching node to a second node of the supply; and drive, during a third portion of the switching period, the first switching element to refrain from connecting the switching node to the first node of the supply, the second switching element to refrain from connecting the switching node to the second node of the supply, and a third switching element to electrically connect the switching node to a second node of the inductive element.

Clause 2: The controller circuitry of clause 1, wherein the logic circuitry is further configured to drive, during a fourth portion of the switching period, the first switching element to refrain from connecting the switching node to the first node of the supply, the second switching element to refrain from connecting the switching node to the second node of the supply, and the third switching element to refrain from electrically connecting the switching node to the second node of the inductive element.

Clause 3: The controller circuitry of clauses 1-2, wherein a first node of the third switching element is electrically connected to the switching node and a second node of the third switching element is electrically connected to an output node; and wherein the first node of the inductive element is electrically connected to the switching node and a second node of the inductive element is electrically connected to the output node.

Clause 4: The controller circuitry of clauses 1-3, wherein a first node of the first switching element is electrically connected to a first node of the supply and the second node of the first switching element is electrically connected to the switching node; and wherein a first node of the second switching element is electrically connected to the switching node and a second node of the second switching element is electrically connected to a second node of the supply.

Clause 5: The controller circuitry of clauses 1-4, wherein the logic circuitry comprises: a first switching signal generator, wherein to drive the first switching element, the first switching signal generator is configured to generate a first pulse frequency modulated (PFM) switching signal to cause the first switching element to operate in a closed state; a second switching signal generator, wherein to drive the second switching element, the second switching signal generator configured to generate a second PFM switching signal to cause the second switching element to operate in a closed state; a third switching signal generator, wherein to drive the third switching element, the third switching signal generator configured to generate a third PFM switching signal to cause the third switching element to operate in a closed state.

Clause 6: The controller circuitry of clauses 1-5, comprising a capacitive element electrically connected to the second node of the inductive element.

Clause 7: The controller circuitry of clause 6, wherein the inductive element is configured to form a Buck converter.

Clause 8: The controller circuitry of clauses 1-7, the third switching element comprises one or more transistors integrated in the controller circuitry on a common integrated circuit (IC).

Clause 9: The controller circuitry of clauses 1-8, wherein the third switching element comprises one or more NPN transistors; or wherein the third switching element comprises one or more PNP transistors.

Clause 10: The controller circuitry of clauses 1-8, wherein the third switching element comprises two transistors configured in a Darlington configuration.

Clause 11: A method comprising: driving, during a first portion of a switching period, a first switching element to electrically connect a switching node to a first node of a supply, the switching node configured to couple to a first node of an inductive element; driving, during a second portion of the switching period, a second switching element to electrically connect the switching node to a second node of the supply of a controller circuitry; and driving, during a third portion of the switching period, the first switching element to refrain from connecting the switching node to the first node of the supply of the controller circuitry, the second switching element to refrain from connecting the switching node to the second node of the supply, and a third switching element to electrically connect the switching node to a second node of the inductive element.

Clause 12: The method of clause 11, wherein the controller circuitry is further configured to drive, during a fourth portion of the switching period, the first switching element to refrain from connecting the switching node to the first node of the supply, the second switching element to refrain from connecting the switching node to the second node of the supply, and the third switching element to refrain from electrically connecting the switching node to the second node of the inductive element.

Clause 13: The method of clauses 11-12, wherein a first node of the third switching element is electrically connected to the switching node and a second node of the third switching element is electrically connected to an output node; and wherein the first node of the inductive element is electrically connected to the switching node and a second node of the inductive element is electrically connected to the output node.

Clause 14: The method of clauses 11-13, wherein a first node of the first switching element is electrically connected to a first node of the supply and the second node of the first switching element is electrically connected to the switching node; and wherein a first node of the second switching element is electrically connected to the switching node and a second node of the second switching element is electrically connected to a second node of the supply.

Clause 15: The method of clauses 11-14, wherein, driving the first switching element during the first portion of the switching period, the controller circuitry is further configured to generate a first pulse frequency modulated (PFM) switching signal to cause the first switching element to operate in a closed state; wherein, driving the second switching element during the second portion of the switching period, the controller circuitry is further configured to generate a second PFM switching signal to cause the second switching element to operate in the closed state; and wherein, driving the third switching element during the third portion of the switching period, the controller circuitry is further configured to generate a third PFM switching signal to cause the third switching element to operate in the closed state.

Clause 16: A system comprising: a first switching element; a second switching element; a third switching element; and controller circuitry comprising: a switching controller configured to determine a switching period; and logic circuitry electrically coupled with the switching controller and configured to: drive, during a first portion of the switching period, the first switching element to electrically connect a switching node to a first node of a supply, the switching node configured to couple to the first node of an inductive element; drive, during a second portion of the switching period, the second switching element to electrically connect the switching node to a second node of the supply; and drive, during a third portion of the switching period, the first switching element to refrain from connecting the switching node to the first node of the supply, the second switching element to refrain from connecting the switching node to the second node of the supply, and the third switching element to electrically connect the switching node to a second node of the inductive element.

Clause 17: The system of clause 16, wherein the controller circuitry is further configured to drive, during a fourth portion of the switching period, the first switching element to refrain from connecting the switching node to the first node of the supply, the second switching element to refrain from connecting the switching node to the second node of the supply, and the third switching element to refrain from electrically connecting the switching node to the second node of the inductive element.

Clause 18: The system of clauses 16-17, wherein a first node of the first switching element is electrically connected to a first node of a supply and the second node of the first switching element is electrically connected to the switching node; and wherein a first node of the second switching element is electrically connected to the switching node and a second node of the second switching element is electrically connected to a second node of the supply.

Clause 19: The system of claim 16, wherein the logic circuitry comprises: a first switching signal generator configured to drive the first switching element during the first portion of the switching period, the controller circuitry is further configured to generate a first pulse frequency modulated (PFM) switching signal to cause the first switching element to operate in a closed state; a second switching signal generator configured to drive the second switching element during the second portion of the switching period, the controller circuitry is further configured to generate a second PFM switching signal to cause the second switching element to operate in a closed state; and a third switching signal generator configured to drive the third switching element during the third portion of the switching period, the controller circuitry is further configured to generate a third PFM switching signal to cause the third switching element to operate in a closed state.

Clause 20: The system of clauses 16-19, comprising: a capacitive element electrically connected to the second node of the inductive element, wherein the capacitive element and the inductive element are configured to form a Buck converter.

In one or more examples, the functions being performed described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this way, computer-readable media generally may correspond to (1) tangible computer-readable storage media, which is non-transitory. Data storage media may be any available media that can be accessed by one or more computers or one or more processors to retrieve instructions, code and/or data structures for implementation of the techniques described in this disclosure. A computer program product may include a computer-readable medium.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

What is claimed is:

1. Controller circuitry comprising:
a switching controller configured to determine a switching period; and
logic circuitry electrically coupled with the switching controller and configured to:
drive, during a first portion of the switching period, a first switching element to electrically connect a switching node to a first node of a supply, the switching node being configured to couple to a first node of an inductive element;
drive, during a second portion of the switching period, a second switching element to electrically connect the switching node to a second node of the supply; and
drive, during a third portion of the switching period, the first switching element to refrain from connecting the switching node to the first node of the supply, the second switching element to refrain from connecting the switching node to the second node of the supply, and a third switching element to electrically connect the switching node to a second node of the inductive element.

2. The controller circuitry of claim 1, wherein the logic circuitry is further configured to drive, during a fourth portion of the switching period, the first switching element to refrain from connecting the switching node to the first node of the supply, the second switching element to refrain from connecting the switching node to the second node of the supply, and the third switching element to refrain from electrically connecting the switching node to the second node of the inductive element.

3. The controller circuitry of claim 1,
wherein a first node of the third switching element is electrically connected to the switching node and a second node of the third switching element is electrically connected to an output node; and
wherein the first node of the inductive element is electrically connected to the switching node and a second node of the inductive element is electrically connected to the output node.

4. The controller circuitry of claim 1,
wherein a first node of the first switching element is electrically connected to a first node of the supply and the second node of the first switching element is electrically connected to the switching node; and
wherein a first node of the second switching element is electrically connected to the switching node and a second node of the second switching element is electrically connected to a second node of the supply.

5. The controller circuitry of claim 1, wherein the logic circuitry comprises:
a first switching signal generator, wherein to drive the first switching element, the first switching signal generator is configured to generate a first pulse frequency modulated (PFM) switching signal to cause the first switching element to operate in a closed state;
a second switching signal generator, wherein to drive the second switching element, the second switching signal generator configured to generate a second PFM switching signal to cause the second switching element to operate in a closed state;
a third switching signal generator, wherein to drive the third switching element, the third switching signal generator configured to generate a third PFM switching signal to cause the third switching element to operate in a closed state.

6. The controller circuitry of claim 1, comprising a capacitive element electrically connected to the second node of the inductive element.

7. The controller circuitry of claim 6, wherein the inductive element is configured to form a Buck converter.

8. The controller circuitry of claim 1, the third switching element comprises one or more transistors integrated in the controller circuitry on a common integrated circuit (IC).

9. The controller circuitry of claim 1, wherein the third switching element comprises one or more NPN transistors; or wherein the third switching element comprises one or more PNP transistors.

10. The controller circuitry of claim 1, wherein the third switching element comprises two transistors configured in a Darlington configuration.

11. A method comprising:
driving, during a first portion of a switching period, a first switching element to electrically connect a switching node to a first node of a supply, the switching node configured to couple to a first node of an inductive element;
driving, during a second portion of the switching period, a second switching element to electrically connect the switching node to a second node of the supply of a controller circuitry; and
driving, during a third portion of the switching period, the first switching element to refrain from connecting the switching node to the first node of the supply of the controller circuitry, the second switching element to refrain from connecting the switching node to the second node of the supply, and a third switching element to electrically connect the switching node to a second node of the inductive element.

12. The method of claim 11,
wherein the controller circuitry is further configured to drive, during a fourth portion of the switching period, the first switching element to refrain from connecting the switching node to the first node of the supply, the second switching element to refrain from connecting the switching node to the second node of the supply, and the third switching element to refrain from electrically connecting the switching node to the second node of the inductive element.

13. The method of claim 11,
wherein a first node of the third switching element is electrically connected to the switching node and a second node of the third switching element is electrically connected to an output node; and
wherein the first node of the inductive element is electrically connected to the switching node and a second node of the inductive element is electrically connected to the output node.

14. The method of claim 11,
wherein a first node of the first switching element is electrically connected to a first node of the supply and the second node of the first switching element is electrically connected to the switching node; and
wherein a first node of the second switching element is electrically connected to the switching node and a second node of the second switching element is electrically connected to a second node of the supply.

15. The method of claim 11,
wherein, driving the first switching element during the first portion of the switching period, the controller circuitry is further configured to generate a first pulse frequency modulated (PFM) switching signal to cause the first switching element to operate in a closed state;
wherein, driving the second switching element during the second portion of the switching period, the controller circuitry is further configured to generate a second PFM switching signal to cause the second switching element to operate in the closed state; and
wherein, driving the third switching element during the third portion of the switching period, the controller circuitry is further configured to generate a third PFM switching signal to cause the third switching element to operate in the closed state.

16. A system comprising:
a first switching element;
a second switching element;
a third switching element; and
controller circuitry comprising:
a switching controller configured to determine a switching period; and
logic circuitry electrically coupled with the switching controller and configured to:
drive, during a first portion of the switching period, the first switching element to electrically connect a switching node to a first node of a supply, the switching node configured to couple to the first node of an inductive element;
drive, during a second portion of the switching period, the second switching element to electrically connect the switching node to a second node of the supply; and
drive, during a third portion of the switching period, the first switching element to refrain from connecting the switching node to the first node of the supply, the second switching element to refrain from connecting the switching node to the second node of the supply, and the third switching element to electrically connect the switching node to a second node of the inductive element.

17. The system of claim 16, wherein the controller circuitry is further configured to drive, during a fourth portion of the switching period, the first switching element to refrain from connecting the switching node to the first node of the supply, the second switching element to refrain from connecting the switching node to the second node of the supply, and the third switching element to refrain from electrically connecting the switching node to the second node of the inductive element.

18. The system of claim 16,
wherein a first node of the first switching element is electrically connected to a first node of a supply and the second node of the first switching element is electrically connected to the switching node; and
wherein a first node of the second switching element is electrically connected to the switching node and a second node of the second switching element is electrically connected to a second node of the supply.

19. The system of claim 16,
wherein the logic circuitry comprises:
a first switching signal generator configured to drive the first switching element during the first portion of the switching period, the controller circuitry is further configured to generate a first pulse frequency modulated (PFM) switching signal to cause the first switching element to operate in a closed state;
a second switching signal generator configured to drive the second switching element during the second portion of the switching period, the controller circuitry is further configured to generate a second PFM switching signal to cause the second switching element to operate in a closed state; and
a third switching signal generator configured to drive the third switching element during the third portion of the switching period, the controller circuitry is further configured to generate a third PFM switching signal to cause the third switching element to operate in a closed state.

20. The system of claim 16, comprising:
a capacitive element electrically connected to the second node of the inductive element,
wherein the capacitive element and the inductive element are configured to form a Buck converter.
